(19) United States
(12) Patent Application Publication
(10) Pub. No.: US 2005/0065753 A1
(43) Pub. Date: Mar. 24, 2005

(54) Apparatus and method for monitoring system health based on fuzzy metric data ranges and fuzzy rules

(75) Inventors: Joseph Phillip Bigus, Rochester, MN (US); Donald Allen Schlosnagle, Rochester, MN (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/670,149

(22) Filed: Sep. 24, 2003

(51) Int. Cl. G06F 11/30; G06F 15/00; G21C 17/00; G06N 7/02; G06N 7/06; G06F 9/44

(52) U.S. Cl. 702/186

(57) ABSTRACT

A method and apparatus for determining the status of a computer system and software applications running on that system and displaying the status to a system administrator are provided. With the apparatus and method, metrics related to a particular application or subsystem are identified and then collected over a predetermined period of time using a data monitoring or collection facility to generate metric history data. Once collected, the metric history data is analyzed by computing a set of parameters representing statistical measures of the metric history data. A set of fuzzy rules are used to define the relationships between metrics and the ultimate application or subsystem status. This metric history analysis phase may be performed periodically such that the fuzzy sets are dynamically redefined at periodic intervals. The fuzzy rules are then evaluated using a fuzzy reasoning process and an overall status indication is generated. As system performance or status changes, the monitoring system can adapt by changing the shape of the “normal” fuzzy set based on the distribution of metric values. The rules may remain the same but the fuzzy set may change dynamically. This greatly reduces maintenance costs since the monitoring rule set can be slowly tuned over time, while the underlying “normal” fuzzy sets could be adjusted as often as needed. Thus, the method and apparatus provide a mechanism to express the knowledge about the key underlying relationships as fuzzy rules and then to automatically tailor the fuzzy sets that are referenced in the fuzzy rules using statistical data mining techniques.

### BACKGROUND OF THE INVENTION

1. Technical Field

The present invention relates to the field of computer system monitoring, and in particular, to the computation and display of the status of operating system, middleware, and application software running on a computer system.

2. Description of Related Art

Monitoring computer system or application performance is a complex task. There can be tens or hundreds of underlying metrics (CPU utilization, queue lengths, number of threads, etc.) which contribute to an overall measure of system performance. The most common approach is to identify the appropriate metrics for a specific purpose and set explicit numeric thresholds for the monitoring software to test these metrics against at specified intervals. When metrics go over specified thresholds then alert events are usually signaled to a centralized administration console indicating an error condition.

While this traditional approach is simple, it has many drawbacks. Individual metrics are poor indicators of overall system state. Metric values may tend to oscillate in a range and they could trigger and retrigger alarms as they cross the fixed threshold. Additionally, metric values may naturally vary over a wide range, making the selection of an appropriate threshold value very difficult. Consequently, many false alarms are usually issued. To reduce the number of false alarms, averaging of metric values or more complex triggering reset mechanisms can be used.

For example the IBM iSeries Management Central systems management products allow users to set a trigger (high) threshold and a reset (low) threshold. Alert events are only signaled when the metric exceeds the trigger threshold after passing below the reset threshold. The Tivoli Manager for Windows systems management product uses Boolean rules that test multiple metrics at the same time, combined with a complex scheme that counts the number of times the set of metrics exceed the threshold in a specified window of time. Although more sophisticated, these alternate monitoring algorithms still result in a binary alarm or no-alarm decision resulting in an alert event being sent to the administration console.

U.S. Pat. No. 5,557,547 describes an approach using multiple thresholds and a radial graphical display. U.S. Pat. No. 5,949,976 describes a performance monitoring and graphic system using data collection scripts and an electronic mail network. Examples of other known mechanisms include Concord Communications, which uses a set of thresholds to partition a performance metric into four health indices, poor, fair, good, and excellent. Points are assigned to each condition (poor=0, fair=2, good=4, and excellent=8) and a set of indices are summed to compute an overall health index.

An alternative means for monitoring system health is to monitor a set of metrics and partition the system state into three modes, representing normal, warning, and error conditions. A “traffic light” iconic display can be used, where green indicates normal system state, yellow indicates a warning system state, and red indicates an error system state. While this type of display provides more information than the binary alert approach, it adds increased complexity to the monitoring system because an algorithm must be derived to compute the ternary system state from the set of performance metrics or from a stream of binary alarm events. Often these algorithms are not exposed to the end-users or administrators and so they are unable to gauge the appropriateness of the green/yellow/red state classifications to the underlying performance metrics.

Thus, it would be beneficial to have an apparatus and method for monitoring the health of a system which provides for the dynamic modification of the alert thresholds based on collected metric data and permits monitoring of metrics using a natural language knowledge representation that is easily understood by system administrators.

### SUMMARY OF THE INVENTION

The present invention addresses these and other problems associated with the prior art in providing a concise, easily understood method and apparatus for determining the status of a computer system and software applications running on that system and displaying the status to a system administrator. With the apparatus and method of the present invention, metrics related to a particular application or subsystem are identified and then collected using a data monitoring or collection facility such as Tivoli Distributed Monitor or Microsoft Windows Management Infrastructure (WMI). The metrics may include processor utilization, page fault rates, and other similar metrics indicating the workload and resource utilization of the computer system. These metrics are collected over a specified period of time under varying realistic workloads to define the expected range of values for each metric in the anticipated operating environment. This data is referred to as the metric history data.

Once collected, the metric history data is analyzed by computing a set of parameters representing statistical measures of the metric history data. For example, the minimum, mean, maximum, and standard deviation for each metric at a collection of time intervals may be computed. As an example, the mean CPU utilization and standard deviation could be computed for every 10 minute time period in a 24 hour operating cycle over several weeks.

A set of fuzzy rules are used to define the relationships between metrics and the ultimate application or subsystem status. These fuzzy rules refer to the metric in a natural linguistic manner, such as “if CPU performance is normal,” “if CPU performance is low,” “if CPU performance is very high,” and the like. The actual numeric definition of the fuzzy sets “low,” “normal,” and “high” are defined using the parameters found during the metric history analysis phase. This metric history analysis phase may be performed periodically such that the fuzzy sets are dynamically redefined at periodic intervals.

Given a set of metrics to monitor, the set of fuzzy rules defining the relationships of those metric states and the application or subsystem status, and the metric history data set, the values for the fuzzy sets “low,” “normal,” “high,” etc. may be defined for each metric. The fuzzy rules are then evaluated using a fuzzy reasoning process and an overall status indication is generated. For example, a “traffic light” iconic representation of the system status may be generated in which the various indicators red, yellow, and green indicate certain levels of system health. This “traffic light” iconic representation may be provided via a user interface, for example.

When the present invention is applied to a set of hierarchically related applications and subsystems, the user interface may allow an administrator to “drill-down” from a high level view to examine the status of individual applications and subsystems contributing to that overall status. Each application/subsystem may have its own “traffic light” iconic representation for representing the health of that particular component of the system.

Thus, the present invention provides a method and apparatus to collect and mine performance data to define fuzzy sets over the anticipated discourse or domain for that metric. Fuzzy rules are then used to reason about the metrics in a natural language format. The invention also enables the hierarchical construction of groups of system monitors using fuzzy rules, resulting in a large reduction in the amount of data that an administrator needs to attend to.

One principle advantage of this invention is to allow the monitoring of metrics using a natural language knowledge representation (e.g., fuzzy if-then rules) and a way to ignore “normal” behavior of a metric (or set of metrics) while easily specifying the actions to be taken when the metric (or set of metrics) goes out of “normal” range. In one exemplary embodiment, the present invention solves the problems of the prior art noted above by formulating metric “normal” states as Gaussian or other kernel-shaped fuzzy sets and then using fuzzy rules to reason about the metrics rather than using simple Boolean threshold tests. The fuzzy rule formulation of this problem is more natural to experts because the fuzzy rules allow the use of linguistic hedges (some, almost, very) to be used in describing metric states.

As system performance or status changes, the monitoring system can adapt by changing the shape of the “normal” fuzzy set based on the distribution of metric values. The rules may remain the same but the fuzzy set may change dynamically. This greatly reduces maintenance costs since the monitoring rule set can be slowly tuned over time, while the underlying “normal” fuzzy sets could be adjusted as often as needed. In fact, the normal range for a metric is highly dependent on the particular system and workload being handled on that system. The present invention provides a mechanism to express the knowledge about the key underlying relationships as fuzzy rules and then to automatically tailor the fuzzy sets that are referenced in the fuzzy rules using statistical data mining techniques.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which the present invention may be implemented;

FIG. 2 is an exemplary block diagram of a server computing device in which aspects of the present invention may be implemented;

FIG. 3 is an exemplary block diagram of a client computing device in which aspects of the present invention may be implemented;

FIG. 4 is an exemplary diagram illustrating the interaction of software components of one or more computing devices in accordance with one exemplary embodiment of the present invention;

FIG. 5 is an exemplary diagram illustrating an overall architecture of one exemplary embodiment of the present invention including a system level rule set, three subsystem rule sets, and a plurality of performance metrics;

FIG. 6 is an exemplary diagram illustrating an architecture of one exemplary embodiment of the present invention when applied to an IBM WebSphere monitoring environment;

FIG. 7 is an exemplary diagram of a fuzzy rule set in accordance with one exemplary embodiment of the present invention;

FIG. 8 is a flowchart outlining an exemplary operation of one exemplary embodiment of the present invention during build-time;

FIG. 9 is a flowchart outlining an exemplary operation of one exemplary embodiment of the present invention in a runtime environment; and

FIG. 10 is a flowchart outlining an exemplary operation of one exemplary embodiment of the present invention when dynamically updating the fuzzy sets based on metric history data.

### DETAILED DESCRIPTION OF THE PREFERRED EMBODIMENTS

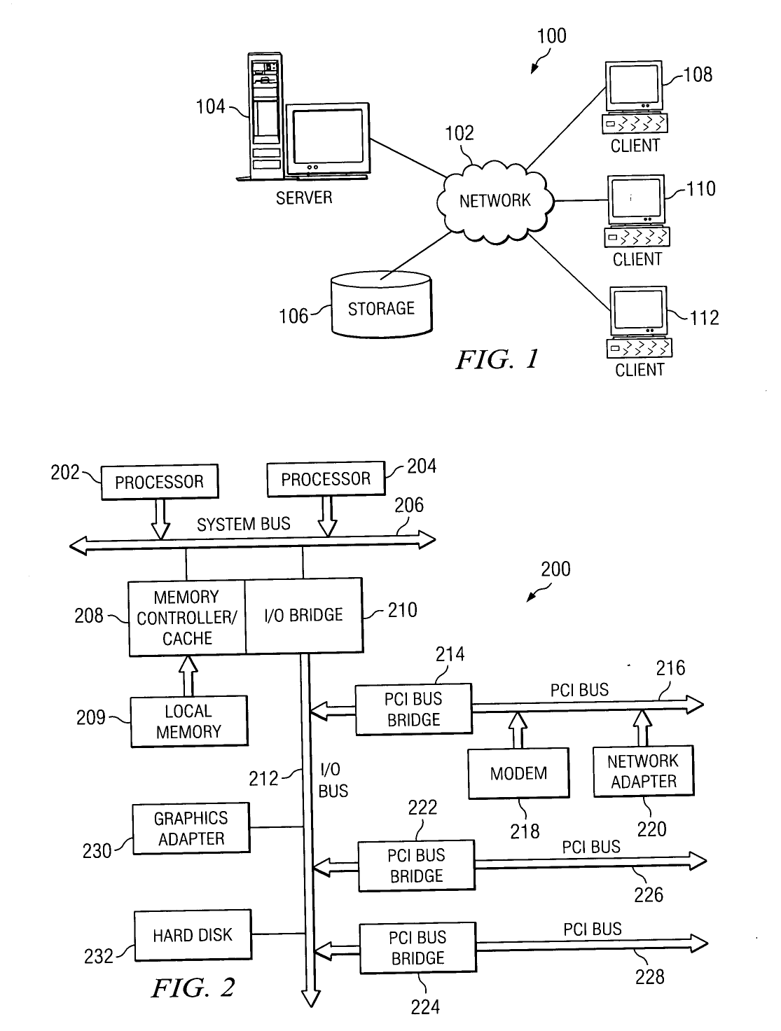

The present invention provides mechanisms for monitoring the health of applications, subsystems, and systems in which the underlying “normal” set may defined in accordance with statistical data mining of metric history data and in which the rules defining the relationships between metrics and system health are defined in a natural language manner. The embodiments of the present invention may be implemented in a stand-alone computing system or a distributed computing system. As such, the following FIGS. 1-3 are intended to provide a context for the description of the functions and operations of the present invention following thereafter. That is, the functions and operations described herein may be performed in one or more of the computing devices described in FIGS. 1-3.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 maybe, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in which aspects of the present invention may be implemented. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

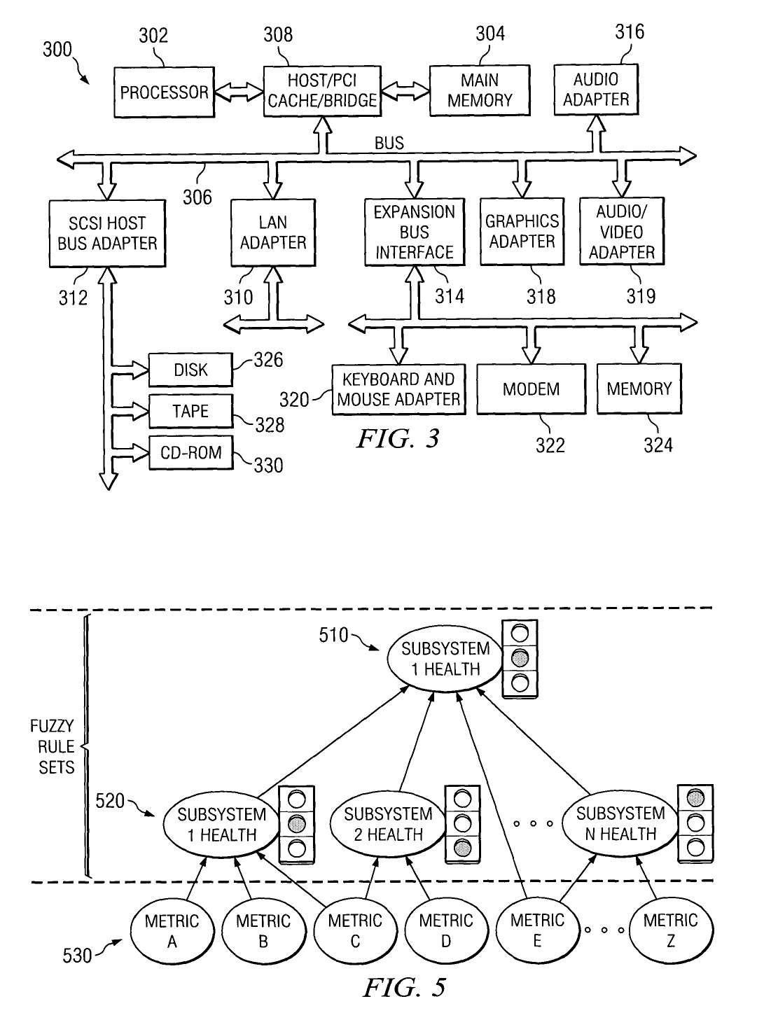

With reference now to FIG. 3, a block diagram illustrating a data processing system is depicted in which the present invention may be implemented. Data processing system 300 is an example of a client computer or stand alone computer in which aspects of the present invention may be implemented. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides apparatus and methods for monitoring the health of systems using fuzzy rules defining the relationships between metrics of the systems and fuzzy sets defining various operational ranges of these systems based on mining of metric history data. With the apparatus and method of the present invention, metrics related to a particular application or subsystem are identified and then collected using a data monitoring or collection facility such as Tivoli Distributed Monitor or Microsoft Windows Management Infrastructure (WMI). The metrics may be any type of metric deemed appropriate for monitoring as providing an indication as to system, subsystem, or application health. For example, these metrics may include, for example, processor utilization, page fault rates, number of threads, number of hits on a web site, number of database queries, number of database connections, and other similar metrics indicating the workload and/or resource utilization of the computer system. These metrics are collected over a specified period of time under varying realistic workloads to define the expected range of values for each metric in the anticipated operating environment. This data is referred to as the metric history data.

Once collected, the metric history data is analyzed by computing a set of parameters representing statistical measures of the metric history data. This analysis of the metric history data is referred to as statistical data mining of the metric history data and may make use of known data mining techniques. For example, the minimum, mean, maximum, and standard deviation for each metric at a collection of time intervals may be computed. As an example, the mean CPU utilization and standard deviation could be computed for every 10 minute time period in a 24 hour operating cycle over several weeks.

While the preferred embodiments make use of statistical data mining techniques for obtaining information to define fuzzy sets for the various metrics, the present invention is not limited to any particular method of data mining of the metric history data, statistical or otherwise. That is, any manner of analyzing the metric history data that provides useful information regarding ranges of the metrics that represent normal and outside normal performance is intended to be within the spirit and scope of the present invention.

A set of fuzzy rules are used to define the relationships between metrics and the ultimate application or subsystem status. These fuzzy rules refer to the metric in a natural linguistic manner, such as “if CPU performance is normal,” “if CPU performance is low,” “if CPU performance is very high,” and the like. An example of a fuzzy rule using this natural linguistic definition format is as follows:
if CPUHealth is Robust and
   ServerHealth is Nominal and
   JVMHealth is Robust
then
   SystemConcern is positively LOW

The actual numeric definition of the fuzzy sets “low,” “normal,” “high”, “Robust”, “Nominal”, etc. are defined using the parameters found during the metric history analysis phase. This metric history analysis phase is performed at build time but may also be performed periodically such that the fuzzy sets are dynamically redefined at periodic intervals.

Given a set of metrics to monitor, the set of fuzzy rules defining the relationships of those metric states and the application or subsystem status, and the metric history data set, the values for the fuzzy sets “low,” “normal,” “high,” etc. may be defined for each metric. The fuzzy rules are then evaluated using a fuzzy reasoning process and an overall status indication is generated. For example, a “traffic light” iconic representation of the system status may be generated in which the various indicators red, yellow, and green indicate certain levels of system health. This “traffic light” iconic representation may be provided via a user interface, for example.

When the present invention is applied to a set of hierarchically related applications and subsystems, the user interface may allow an administrator to “drill-down” from a high level view to examine the status of individual applications and subsystems contributing to that overall status. Each application/subsystem may have its own “traffic light” iconic representation for representing the health of that particular component of the system.

While the preferred embodiments of the present invention are described in terms of “traffic light” iconic representations being generated in a graphical user interface to represent system, subsystem and application health, the present invention is not limited to such. Other representations of the health of the system, subsystems and applications may be used including graphs, numeric outputs, audible alarms or announcements, tactile output, and the like. In short, any method of representing the status of the system, subsystems, and applications is intended to be within the spirit and scope of the present invention.

Thus, the present invention provides a method and apparatus to collect and mine performance data to define fuzzy sets over the anticipated discourse or domain for that metric. Fuzzy rules are then used to reason about the metrics in a natural language format. The invention also enables the hierarchical construction of groups of system monitors using fuzzy rules, resulting in a large reduction in the amount of data that an administrator needs to attend to.

One principle advantage of this invention is to allow the monitoring of metrics using a natural language knowledge representation (e.g., fuzzy if-then rules) and a way to ignore “normal” behavior of a metric (or set of metrics) while easily specifying the actions to be taken when the metric (or set of metrics) goes out of “normal” range. In one exemplary embodiment, the present invention solves the problems of the prior art noted above by formulating metric “normal” states as Gaussian or other kernel-shaped fuzzy sets and then using fuzzy rules to reason about the metrics rather than using simple Boolean threshold tests. The fuzzy rule formulation of this problem is more natural to experts because the fuzzy rules allow the use of linguistic hedges (some, almost, very) to be used in describing metric states.

As system performance or status changes, the monitoring system can adapt by changing the shape of the “normal” fuzzy set based on the distribution of metric values. The rules may remain the same but the fuzzy set may change dynamically. This greatly reduces maintenance costs since the monitoring rule set can be slowly tuned over time, while the underlying “normal” fuzzy sets could be adjusted as often as needed. In fact, the normal range for a metric is highly dependent on the particular system and workload being handled on that system. The present invention provides a mechanism to express the knowledge about the key underlying relationships as fuzzy rules and then to automatically tailor the fuzzy sets that are referenced in the fuzzy rules using statistical data mining techniques.

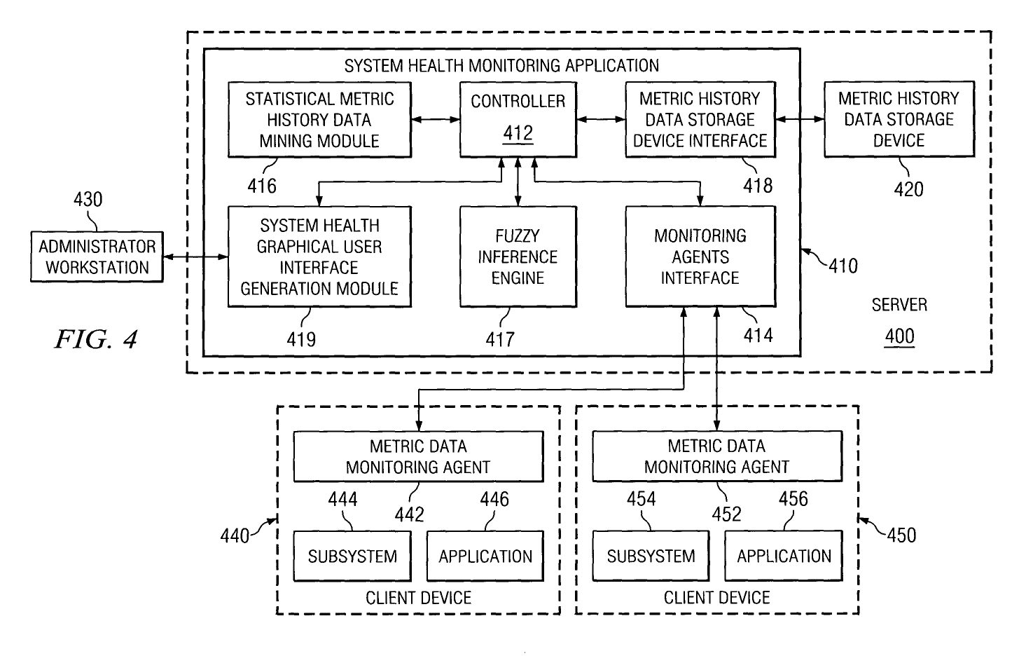

FIG. 4 is an exemplary diagram illustrating the interaction of software components of one or more computing devices in accordance with one exemplary embodiment of the present invention. The exemplary embodiment shown in FIG. 4 is for a distributed data processing system in which some aspects of the present invention are implemented in a server computing device while others are implemented on client computing devices. It should be appreciated that the present invention need not be in a distributed data processing system but may be implemented entirely within a stand-alone computing device. In such a case, the elements shown in FIG. 4 may be included in a single computing device rather than multiple computing devices as depicted. Furthermore, rather than being in a client server, the present invention may be implemented in any other type of server computing device such as a peer-to-peer server, or the like.

As shown in FIG. 4, a server 400 is provided with a system health monitoring subsystem 410 and a metric history data storage device 420. The system health monitoring subsystem 410 includes a controller 412, a monitoring agents interface 414, a statistical metric history data mining module 416, a fuzzy inference engine 417, a metric history data storage device interface 418, and a system health graphical user interface generation module 419. These elements of the system health monitoring subsystem 410 are in communication with one another via controller 412 and a system bus (not shown). Although a bus architecture is used in a preferred embodiment, the present invention is not limited to such and any architecture may be used that facilitates the communication of control/data signals between the elements 412-419.

Also illustrated in FIG. 4 are client devices 440 and 450. The client devices 440 and 450 include subsystems 444, 454 and applications 446, 456 which are monitored by the metric data monitoring agents 442, 452. That is, the metric data monitoring agents 442, 452 compile metric data information about the client devices 440, 450, their subsystems 444, 454, and applications 446, 456, and provide this metric data to the system health monitoring subsystem 410 of server 400. The metric data monitoring agents 442, 452 may be any type of known or later developed metric monitoring software or hardware. Examples of known metric monitoring agents that may be used with the present invention include Tivoli Distributed Monitor and Microsoft Windows Management Infrastructure (WMI).

The system health monitoring subsystem 410 may periodically collect metric data from the metric data monitoring agents 442 and 452 and store this metric information in the metric history data storage device 420 via the interfaces 414 and 418. The metric data may be obtained by the periodic reporting of the metric data to the system health monitoring subsystem 410 by the metric data monitoring agents 442 and 452 or may be obtained in response to a request from the controller 412 for the collected metric data from the metric data monitoring agents 442.

The metric data is preferably collected for a period of time to generate a history of metric data in the metric history data storage device 420. This period of time may be provided to the controller 412 as an operational parameter and may be modifiable as necessary. Once a history of metric data is established within the metric history data storage device 420 for the various client systems, subsystems, and applications being monitored by the system health monitoring subsystem 410, the controller 412 instructs the metric history data to be retrieved and analyzed by the statistical metric history data mining module 416.

Statistical metric history data mining module 416 retrieves the metric history data for each system, subsystem, and/or application of interest from the metric history data storage device 420 and performs analysis on the metric history data to discern fuzzy ranges of normal performance of the various systems, subsystems, and/or applications. In addition, the statistical metric history data mining module 416 may discern other ranges of performance including, for example, low performance, high performance, robust performance, terminal performance, and the like. These ranges of performance may then be stored as fuzzy sets that are utilized by the system health monitoring subsystem 410 to evaluate measurements of system, subsystem, and/or application performance during runtime.

The analysis performed by the statistical metric history data mining module 416 may take many different forms. In a preferred embodiment, the analysis may include statistical data mining of the metric history data to obtain statistical measures of the distribution of the metric history data. For example, the statistical measures may include the minimum and maximum values, mean, median, standard deviation of the metric history data. This information may then be used to determine values of a metric that comprise “normal” operation of the subsystem or application. In addition, the other ranges of operations noted above may be determined based on these statistical analysis values.

Once the ranges of operation are determined, they are stored as fuzzy sets for use by the system health monitoring subsystem 410 in determining whether a subsystem or application of a client device is currently operating in a normal operating manner or in another operating range. Fuzzy rules may then be determined, or may have been previously determined, for use with the fuzzy sets and current metric measurements of subsystems 444, 454 and applications 446, 456, to determine the health of the client devices 440, 450 and the system as a whole.

The fuzzy rules are natural language rules that define the relationship of metrics to their range of operation and to the other metrics of the subsystem/application. That is, the fuzzy rules define conditions that lead to a particular status of the subsystem/application being determined. These conditions involve first, a determination of the range of operation, or fuzzy set, in which the current metric measurements fall, and then a determination of the particular relationship of the current metric measurements with each other. The fuzzy rules take the form of, for example, if-then rules. Of course, other types of rules may be used without departing from the spirit and scope of the present invention.

The fuzzy rules allow programmers and administrators to use fuzzy language that provides hedges that are readily understandable to human beings. For example, a fuzzy rule may allow the use of the terms “some”, “almost”, “very”, “normal”, “high”, “low”, and the like. Thus, for example, a fuzzy rule may take the form of “if metric A is very high, and metric B is almost high, then subsystem is high”. The terms “some”, “almost”, and “very” are hedges, i.e. intensification transformers that reduce the candidate space so that the truth of something that was “hot,” for example, may now fall outside of “very hot.” Definitions of fuzzy set terms such as “normal,” “high,” and “low” are established by the programmer or administrator. Hedges, on the other hand, have standard meanings and are known to concentrate, dilute, or negate the fuzzy region in standard ways. The manner by which the concentration, dilution or negation is performed is specific to the particular implementation and is based upon algorithms established for these various hedges.

The fuzzy rules may be semi-permanent in nature. That is, the fuzzy rules are intended to be change relatively infrequently while the fuzzy sets may be modified frequently to adjust them to the particular operational conditions of the computing environments. That is, the data used to determine the fuzzy sets, by its nature, goes through periods in which the definition of “normal” operation is not the same as in a previous period of time. As a result, the present invention permits dynamic updating of the fuzzy sets at periodic intervals, when instructed by an administrator, or when an event occurs indicating that the fuzzy sets need to be redefined.

Thus, it is important to be able to update the fuzzy sets to provide a more accurate reflection of what the “normal” operation of a subsystem, system or application is. On the other hand, however, the relationships between the metrics and the health of the system, subsystem, or application, typically does not change as frequently. The present invention allows the fuzzy rules to be defined in such a manner that they are not affected by the redefining of the fuzzy sets. Only the outcome of the application of the fuzzy rules to the fuzzy sets and current metric measurements may be different from a previous application of the fuzzy rules due to the changes in the fuzzy sets.

Once the fuzzy sets and fuzzy rules are defined, the system health monitoring subsystem 410 may use these data structures to evaluate current metric measurements for the subsystems 444, 454 and applications 446, 456 of the client devices 440 and 450. This evaluation may lead to an evaluation as to the health of the computing system as a whole. Essentially, the metric values for the subsystems and/or applications are retrieved and provided to the fuzzy inference engine 417. The fuzzy inference engine 417 compares the metric values to the fuzzy sets to determine in which fuzzy set they fall. Additionally, the fuzzy inference engine 417 may determine whether the metric value is within a particular area of a fuzzy set in order to determine whether the metric value is “very”, “some”, “almost” or some other subjective evaluation.

Once it is determined which fuzzy sets contain the metric values, the fuzzy inference engine 417 applies fuzzy rules to determine which fuzzy rules are satisfied by the current status of the metric values. The resulting output from the application of the fuzzy rules is provided to the system health graphical user interface (GUI) generation module 419 to generate a GUI to be output to the administrator workstation 430. This GUI may include text, graphics, audio, and the like. In a preferred embodiment, the GUI includes a “traffic light” iconic representation of the health of the system, subsystem, application, etc., with which the traffic light icon is associated.

The GUI provides the administrator with information regarding the current health of the system, subsystems, and applications. The GUI also permits the administrator to navigate through various levels of detail of information such that the administrator may “drill-down” the system hierarchy to determine the health of the system at various levels. As a result, the administrator is given a comprehensive output of the system health that is easily manipulatable and is as accurate as possible since the fuzzy sets are updated to be current with current operational environment conditions.

FIG. 5 is an exemplary diagram illustrating an overall architecture of one exemplary embodiment of the present invention including a system level rule set, three subsystem rule sets, and a plurality of performance metrics. As shown in FIG. 5, the architecture of the depicted embodiment takes the form of a node tree in which leaf nodes 530 comprise the various metrics measured by the metric data monitoring agents. Fuzzy rule sets are established for each of the subsystems and/or applications 520 that determine the status of the subsystems/applications based on the metric values in the leaf nodes 530. Additionally, fuzzy rules are established for determining the relationship between the status of the subsystems/applications 520 and the status of a higher level subsystem or system 510. These fuzzy rules may also take into account the specific values of some or all of the metrics, such as metric E in the depicted example, when determining the status of the higher level subsystem or system 510. Thus, the nature of the fuzzy rules is to define the relationship between metrics and/or the relationship between subsystem/application status to determine an ultimate evaluation of a system, subsystem, or application health.

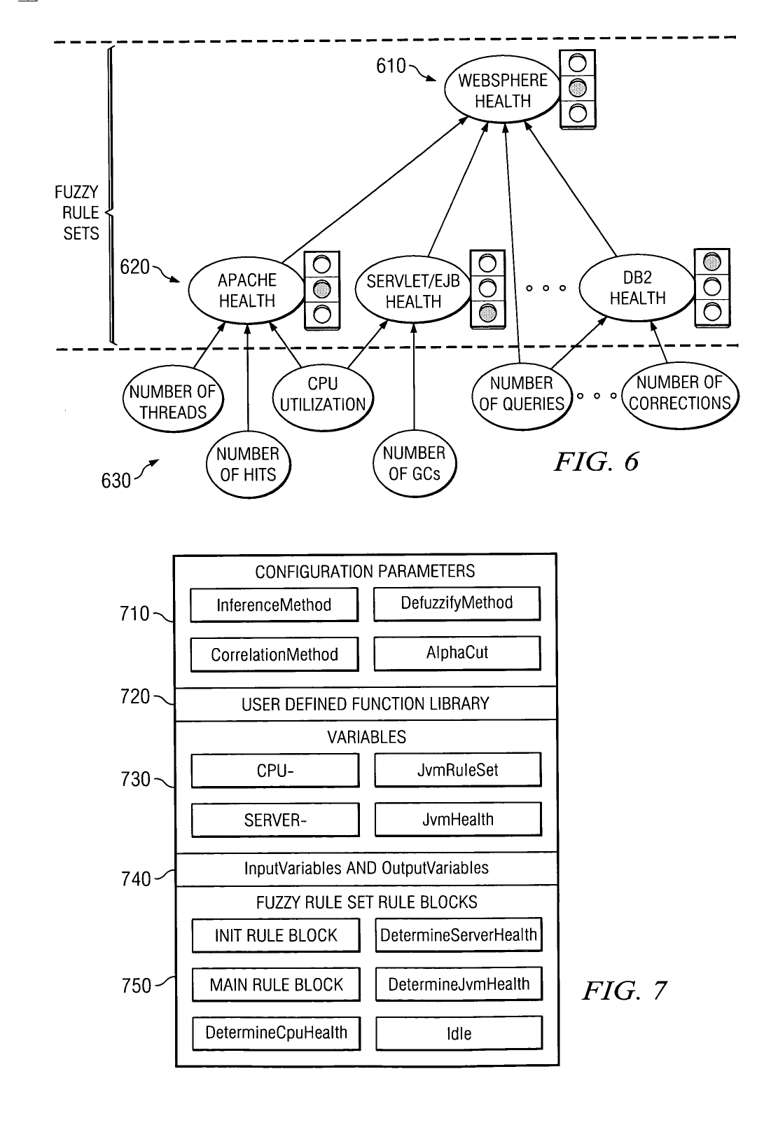

FIG. 6 is an exemplary diagram illustrating an architecture of one exemplary embodiment of the present invention when applied to an IBM WebSphere monitoring environment. As shown in FIG. 6, the metrics in the leaf nodes 630 include number of threads, number of hits to a web site, CPU utilization, number of garbage collections (GCs) performed, number of queries, number of connections, and the like. Fuzzy rules are established for determining the health of the subsystems 620 which include the Apache server, the Servlet/Enterprise Java Bean, the database application DB2, and the like. In addition, fuzzy rules are established for determining the health of the WebSphere environment 610 based on the health of the subsystems 620 and the number of queries. The various metrics are evaluated by the fuzzy rules to determine the health of the subsystems 620 and the system 610. A graphical user interface (GUII) is then generated that indicates the health of the system 610 and subsystems 620. This GUI allows the administrator to traverse the nodal tree to determine information about the system at various levels.

FIG. 7 is an exemplary diagram of a fuzzy rule set in accordance with one exemplary embodiment of the present invention. As shown in FIG. 7, a fuzzy rule set contains several sections. At the top of the fuzzy rule set are configuration parameters 710 for the fuzzy inference engine. The first configuration parameter, InferenceMethod, specifies which of several fuzzy inferencing techniques is to be used by the inference engine. Examples of such fuzzy inferencing techniques include ProductOr, MinMax, which updates an output variable's fuzzy region by the maximum of predicate truth minimums, and FuzzyAdd which is a technique that also reduces the consequent region by the minimum of the predicate truth, but the output fuzzy region is a bounded-add. The configuration parameter CorrelationMethod specifies how the inference engine is to correlate the consequent of any rule with the rule's predicate truth. DefuzzifyMethod specifies which technique is to be used to turn fuzzy solutions into numeric values when passed to non-fuzzy components. Lastly, AlphaCut specifies the threshold at which predicate truth values become insignificant and prevent a rule's consequent clauses from being evaluated. After the inference engine configuration parameters 710, a user defined function library 720 is imported for use in the rules.

The Variables section 730 of the fuzzy rule set defines all of the global variables used in the fuzzy rule set. These include fuzzy variables with associated fuzzy set definitions. Some variables, such as Cpu-, Server-, and JvmRuleSet, hold the subsystem fuzzy rule set objects which are invoked in turn. Some variables, such as Cpu-, Server-, and JvmHealth, hold the fuzzy results after each subsystem fuzzy rule set is invoked to determine the individual health of each subsystem. Each fuzzy solution space, such as CpuHealth, is broken into the overlapping fuzzy regions, e.g., Robust, Nominal, and Terminal. This allows rules to examine whether “CpuHealth is very Robust” or “CpuHealth is somewhat Terminal.”

The InputVariables and OutputVariables are listed in the next section 740. The InputVariables are the list of all metrics used to evaluate the system health. The output variables are the results of the system health computation performed by the hierarchy of system and subsystem fuzzy rule sets.

Next in the fuzzy rule set is a series of rule blocks 750. Rule blocks are subsets or groups of rules which can be reference and invoked by name. Rule blocks can be through of as macros, collections of rules, etc. Examples of rule blocks include the Init rule block, the main rule block, DetermineCpuHealth, DetermineServerHealth, DetermineJvmHealth, Idle, and the like. The Init rule block is evaluated once by the inference engine after the rule set is created and is used to initialize the fuzzy rule set to a known state, e.g., by giving certain variables known values. The Main rule block is always evaluated after the Init rule block and performs the main controlling logic. The first rules in the Main rule block invoke the rule blocks that determine the health of each individual subsystem. The remaining rules reason about the health of each individual subsystem in relation to the other subsystems to arrive at an overall system health. Finally, a few rules turn the overall system health into an appropriate health indicator.

The DetermineCpuHealth rule block is called from the Main rule block and is used to invoke the fuzzy rule set that determines the individual health of the CPU subsystem. The first several rules of this fuzzy rule set simply build the argument list to the fuzzy rule set to be invoked. The arguments are, of course, the metrics relating to CPU health and are passed to the invoked fuzzy rule set by placing the metrics in the input buffer. Another rule clears the result variable of any values left over from a previous invocation of the rule block, and a single rule, containing is used to invoke the fuzzy rule set dealing with the CPU subsystem. The invoked fuzzy rule set returns multiple values. The zero-th element of the returned list is a health indication for the CPU and is assigned to the variable CpuIndicator. The final rule of the rule block assigns the next (or first) element of the result to CpuHealth, which is a fuzzy variable.

The DetermineServerHealth rule block is used to invoke the server health subsystem fuzzy rule set. These rules operate identically to the rules in the DetermineCpuHealth rule block except that the metrics passed to, and the results returned from, the fuzzy rule set are those relating to server health.

The DetermineJvmHealth rule block is used to invoke the JVM health subsystem fuzzy rule set. Like the previous two rule blocks, this rule block invokes and obtains results from the fuzzy rule set that determines the health of a particular subsystem component, in this case the Java Virtual Machine.

The Idle rule block is called whenever the Main rule block quiesces. That is, when Main has arrived at a solution or can fire no more rules, the Idle rule block is called. The rules in this rule block simply print out a message to the administrator workstation or console indicating the overall system health. Alternatively, this rule block may be used to invoke the generation of a graphical user interface such as that described previously.

When the data collection routines of the system health monitoring subsystem are ready to present the metrics to the SystemHealth fuzzy rule set, the following processing occurs:
1. The metrics are placed into the SystemHealth fuzzy rule set's input buffer, and the fuzzy rule set is invoked.
2. The inference engine examines the fuzzy rule set's input buffer and assigns the values found there to the variables listed in the InputVariables statement. For example, the first value in the input buffer is assigned to PercentageOfCpuUsed, the next value is assigned to PercentageOfCpuUsedByInterrupt, and so on.
3. The inference engine processes the Main rule block. It does this by first processing all assertion statements, which causes the secondary rule blocks to be invoked one after the other. Each secondary rule block invokes a separate fuzzy rule set as described above, passing in metrics as arguments and obtaining resultant individual subsystem health values. Then all fuzzy rules in the Main rule block are processed to determine the overall system health.
4. Once overall system health is determined, the Idle rule block is processed.

Finally, the values of all variables listed in the OutputVariables statement are placed into the fuzzy rule set's output buffer, thus making the values available to the system health monitoring subsystem.

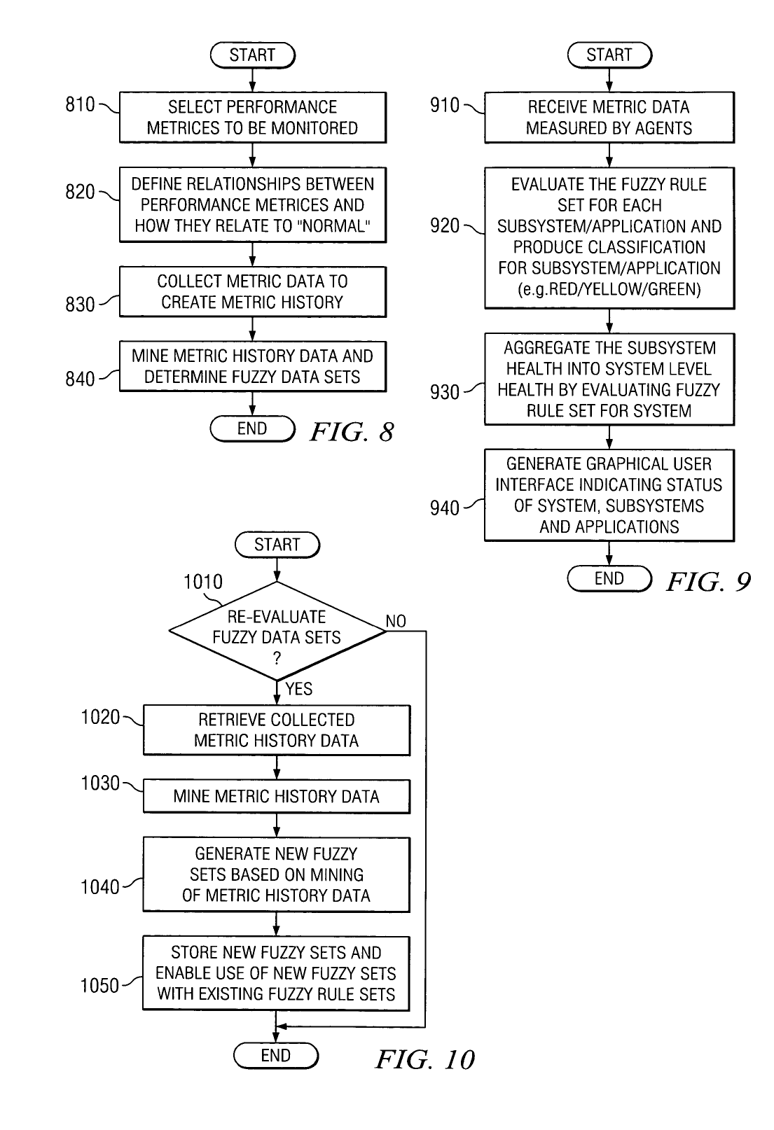

FIGS. 8-10 are flowcharts that illustrate build time and runtime operations according to one exemplary embodiment of the invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 8 is a flowchart outlining an exemplary operation of one exemplary embodiment of the present invention during build-time. As shown in FIG. 8, the operation starts by selecting the performance metrics to be monitored (step 810). The relationships between the performance metrics and how they relate to “normal” system/subsystem/application operation are defined, i.e. the fuzzy rule sets are defined (step 820). The metric data is then collected to create a metric history data structure (step 830). The metric history data is then mined to determine the fuzzy data sets (step 840).

FIG. 9 is a flowchart outlining an exemplary operation of one exemplary embodiment of the present invention in a runtime environment. As shown in FIG. 9, the operation starts by receiving metric data measured by the metric data monitoring agents (step 910). The fuzzy rule set for each subsystem/application is evaluated and a classification for the subsystem/application with regard to health is generated (step 920). The health classifications for each subsystem/application are then aggregated using fuzzy rule sets for the system to generate an indicator of system health (step 930). A graphical user interface is then generated that indicates the status of the system, subsystems, and applications for use by an administrator (step 940).

FIG. 10 is a flowchart outlining an exemplary operation of one exemplary embodiment of the present invention when dynamically updating the fuzzy sets based on metric history data. As shown in FIG. 10, the operation starts by determining if the fuzzy data sets are to be reevaluated (step 1010). This may be a determination as to whether a predetermined time has elapsed since the last update of the fuzzy data sets, a command being received from an administrator to update the fuzzy data sets, or an event, such as an erroneous indication of system health, being experienced.

If it is time to reevaluate the fuzzy data sets (step 1010), then the collected metric history data is retrieved (step 1020). This embodiment assumes that data collected by the metric data monitoring agents during operation of the system is continually stored in the metric history data storage device for later use in reevaluating the fuzzy data sets.

Thereafter, the metric history data is mined (step 1030) and new fuzzy data sets are generated based on the mining of the metric history data (step 1040). The new fuzzy data sets are stored and the existing fuzzy rule sets are enabled to use the new fuzzy data sets (step 1050).

Thus, the present invention provides a mechanism for adapting a system health monitoring apparatus, as system performance or status changes, by changing the shape of the “normal” fuzzy set based on the distribution of metric values. The fuzzy rules that define the relationships between metric values and subsystem health determinations may remain the same but the fuzzy set may change dynamically. This greatly reduces maintenance costs since the monitoring rule set can be slowly tuned over time, while the underlying “normal” fuzzy sets could be adjusted as often as needed. Thus, the present invention provides a mechanism to express the knowledge about the key underlying relationships as fuzzy rules and then to automatically tailor the fuzzy sets that are referenced in the fuzzy rules using statistical data mining techniques.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of determining the health of a computing system component, comprising:
generating at least one fuzzy data set associated with at least one measured metric of the computing system component, wherein the fuzzy data set defines fuzzy regions indicating different categories of the measured metric;
generating at least one fuzzy rule set associated with the at least one measure metric, wherein the fuzzy rule set defines a relationship of the fuzzy regions of the fuzzy data set to categories of computing system component health; and
determining the health of the computing system component based on the at least one fuzzy data set and the at least one fuzzy rule set.

2. The method of claim 1, wherein the at least one fuzzy data set is generated by performing data mining on metric history data, wherein the metric history data includes measured values for the at least one measured metric for a predetermined period of time.

3. The method of claim 2, wherein the data mining includes performing statistical analysis of the metric history data to determine the distribution of the metric history data.

4. The method of claim 1, further comprising:
generating at least one second fuzzy rule set indicating a relationship of the health of the computing system component to the health of at least one other computing system component.

5. The method of claim 1, further comprising:
generating an indicator of the health of the at least one computing system component; and
outputting the indicator.

6. The method of claim 5, wherein outputting the indicator includes outputting a graphical user interface having an indicator for each component of a computing system.

7. The method of claim 1, wherein determining the health of the computing system component based on the at least one fuzzy data set and the at least one fuzzy rule set includes:
applying the at least one fuzzy rule set to metric data collected by a metric data collection facility; and
determining a fuzzy data set in which the metric data is classified based on the application of the at least one fuzzy rule set.

8. The method of claim 7, wherein the at least one fuzzy rule set includes at least one hedge and wherein determining a fuzzy data set in which the metric data is classified includes applying at least one hedge algorithm associated with the at least one hedge to the metric data.

9. A computer program product in a computer readable medium for determining the health of a computing system component, comprising:
first instructions for generating at least one fuzzy data set associated with at least one measured metric of the computing system component, wherein the fuzzy data set defines fuzzy regions indicating different categories of the measured metric;
second instructions for generating at least one fuzzy rule set associated with the at least one measure metric, wherein the fuzzy rule set defines a relationship of the fuzzy regions of the fuzzy data set to categories of computing system component health; and
third instructions for determining the health of the computing system component based on the at least one fuzzy data set and the at least one fuzzy rule set.

10. The computer program product of claim 9, wherein the at least one fuzzy data set is generated by performing data mining on metric history data, wherein the metric history data includes measured values for the at least one measured metric for a predetermined period of time.

11. The computer program product of claim 10, wherein the data mining includes performing statistical analysis of the metric history data to determine the distribution of the metric history data.

12. The computer program product of claim 9, further comprising:
fourth instructions for generating at least one second fuzzy rule set indicating a relationship of the health of the computing system component to the health of at least one other computing system component.

13. The computer program product of claim 9, further comprising:
fourth instructions for generating an indicator of the health of the at least one computing system component; and
fifth instructions for outputting the indicator.

14. The computer program product of claim 13, wherein the fifth instructions for outputting the indicator include instructions for outputting a graphical user interface having an indicator for each component of a computing system.

15. The computer program product of claim 9, wherein the third instructions for determining the health of the computing system component based on the at least one fuzzy data set and the at least one fuzzy rule set include:
instructions for applying the at least one fuzzy rule set to metric data collected by a metric data collection facility; and
instructions for determining a fuzzy data set in which the metric data is classified based on the application of the at least one fuzzy rule set.

16. The computer program product of claim 15, wherein the at least one fuzzy rule set includes at least one hedge and wherein the third instructions include instructions for applying at least one hedge algorithm associated with the at least one hedge to the metric data.

17. An apparatus for determining the health of a computing system component, comprising:
means for generating at least one fuzzy data set associated with at least one measured metric of the computing system component, wherein the fuzzy data set defines fuzzy regions indicating different categories of the measured metric;
means for generating at least one fuzzy rule set associated with the at least one measure metric, wherein the fuzzy rule set defines a relationship of the fuzzy regions of the fuzzy data set to categories of computing system component health; and
means for determining the health of the computing system component based on the at least one fuzzy data set and the at least one fuzzy rule set.

18. The apparatus of claim 17, wherein the at least one fuzzy data set is generated by performing data mining on metric history data, wherein the metric history data includes measured values for the at least one measured metric for a predetermined period of time.

19. The apparatus of claim 18, wherein the data mining includes performing statistical analysis of the metric history data to determine the distribution of the metric history data.

20. The apparatus of claim 17, further comprising:
means for generating at least one second fuzzy rule set indicating a relationship of the health of the computing system component to the health of at least one other computing system component.

21. The apparatus of claim 17, further comprising:
means for generating an indicator of the health of the at least one computing system component; and
means for outputting the indicator.

22. The apparatus of claim 21, wherein the means for outputting the indicator includes means for outputting a graphical user interface having an indicator for each component of a computing system.

23. The apparatus of claim 17, wherein the means for determining the health of the computing system component based on the at least one fuzzy data set and the at least one fuzzy rule set includes:
means for applying the at least one fuzzy rule set to metric data collected by a metric data collection facility; and
means for determining a fuzzy data set in which the metric data is classified based on the application of the at least one fuzzy rule set.

24. The apparatus of claim 23, wherein the at least one fuzzy rule set includes at least one hedge and wherein the means for determining a fuzzy data set in which the metric data is classified includes means for applying at least one hedge algorithm associated with the at least one hedge to the metric data.
